(19) United States
(12) Patent Application Publication
(10) Pub. No.: US 2018/0105775 A1
(43) Pub. Date: Apr. 19, 2018

(54) PACKAGE SUITABLE FOR DELIVERING A LAUNDRY AGENT IN AN AQEUOUS ENVIRONMENT

(71) Applicant: Mari Elizabeth Fox, Weaverville, NC (US)

(72) Inventor: Mari Elizabeth Fox, Weaverville, NC (US)

(21) Appl. No.: 13/926,665

(22) Filed: Jun. 25, 2013

Related U.S. Application Data
(60) Provisional application No. 61/673,291, filed on Jul. 19, 2012.

(51) Int. Cl. C11D 17/04; C11D 9/26

(52) U.S. Cl. CPC C11D 17/042; C11D 9/26

(57) ABSTRACT

An improved package is described wherein the package includes a wrap portion formed in whole or in part of a material at least partially soluble in water. The package comprises soap nuts and a complement material.

### BACKGROUND OF THE INVENTION

The present invention relates to a package suitable for delivering a laundry agent or other cleaning agent in an aqueous environment, especially a laundry agent formed of soap nuts in powdery form.

It has been proposed to provide unit packaging of detergents in packets, often called “sachets”, for direct dosing of laundry agents into washing machines. Such direct dosing packets are proposed as substitutes for bulk packages of powdered and liquid detergents in cartons, drums, and bottles but these already existing laundry agent delivery packages must be designed so that ingredients do not segregate during storage. Also, wastage or under-dosing can occur when the consumer is left to judge the correct amount of a product to use.

Unit packaging of laundry agents for washing machines alleviates these problems and also avoids contact of the detergent composition with the skin of a user.

Packets for unit packaging of detergent powders are disclosed in U.S. Pat. No. 4,188,304 (Lever Bros. Co.) and EP No. 0 011 500011 968 (Unilever). These documents disclose sachets of water-insoluble, water-permeable material, which are clearly unsuitable for the packaging of liquids, and sachets designed to open in use. The latter type of sachet requires seals that are sensitive to the wash water, and they would accordingly be unsuitable, in general, for the packaging of liquids.

U.S. Pat. No. 3,277,009 (GAF Corp) discloses packages made of water-soluble film and their use for the packaging of, inter alia, solid detergent compositions and non-aqueous liquids such as petrol and carbon tetrachloride. Such packages are clearly unsuitable for packaging liquids having an appreciable water content since such liquids would attack the package walls.

CA No. 1 112 534 (Procter & Gamble) discloses a package made of water-soluble film containing a detergent suitable for use in an automatic dishwasher, but the package contents must be in the form of a paste which will not dissolve the film.

U.S. Pat. No. 3,186,869, U.S. Pat. No. 3,322,674 and GB No. 954 602 (Friedman)) disclose a package for bleach-containing detergents in the form of a bag of water-soluble film material. The problem of attack of the bag walls by the contents is here alleviated by providing the inner surfaces of the bag walls with a barrier coating of waxy or oleaginous material, especially paraffin wax.

U.S. Pat. No. 3,790,067 (Scheier) discloses disposable container having an inner layer of water-insoluble polymeric film material and an outer layer of water-soluble polymeric material. The outer layer is relatively strong, and the inner layer is sufficiently thin to be shredded under normal atmospheric forces, or the weight of material in the container, once the outer layer has dissolved away.

Accordingly, it would be desirable if a package for delivering a laundry agent or other cleaning agent in an aqueous environment could be provided that is convenient and, in particular, that is particularly adapted to effectively releasing a soap nut cleaning agent in an aqueous environment.

### SUMMARY OF THE INVENTION

The present invention provides a package for delivering a laundry agent or other cleaning agent in an aqueous environment could be provided that is convenient and, in particular, that is particularly adapted to effectively releasing a soap nut cleaning agent in an aqueous environment.

According to one aspect of the present invention, there is provided a package comprising a wrap portion formed in whole or in part of a material at least partially soluble in water and a contents portion formed of soap nuts and a complement material. According to one variation of the one aspect of the present invention, the wrap portion includes an exterior surface and an interior lining and the interior lining is more resistant to the penetration thereof by an aqueous media than the exterior surface. Also, the soap nuts may be in powdery form.

According to another aspect of the present invention, there is provided a capsule package including a wall having at least two molded components, the at least two sections including at least one moldable material that is water soluble or water dispersible or wherein a substantial part of the surface of the at least two sections is water soluble or water dispersible so as to leave at least one aperture the wall when the capsule package is placed in contact with an aqueous environment, the at least two sections forming a compartment that is accessible to the aqueous environment when the capsule package is exposed to the aqueous environment, and a contents portion formed of soap nuts and a complement material.

The wall of the capsule package may include molded sections which are wholly water soluble or water dispersible. Also, the capsule package may be soluble an aqueous environment no greater than two hundred and ten degrees Fahrenheit. Additionally, the capsule package may be soluble in an aqueous environment no greater than one hundred degrees Fahrenheit. In one version of the capsule package, the sections are welded to form a single indivisible unit. The welding may be on a line around the capsule package and wherein the line is situated on a planar cross-section of the capsule package. Also, the welding may be effected by laser welding.

### BRIEF DESCRIPTION OF THE FIGURES OF THE DRAWINGS

The package suitable for delivering a laundry agent in an aqueous environment of the present invention is illustrated in various Figures of the drawings.

FIG. 1 is a longitudinal cross-sectional view of a capsule package of the invention in its open state;

FIG. 2 is a longitudinal cross-sectional view of a capsule package of the invention in its closed state;

FIG. 3 is a perspective view of the closed capsule package shown in FIG. 1 and showing one portion of the capsule package in a transparent see-through view; and

FIG. 4 is a longitudinal cross-sectional view of a capsule package of the invention in its closed state as shown in FIG. 2 and showing a content portion of the capsule package including soap nuts and a complement material.

### DETAILED DESCRIPTION OF AN EMBODIMENT

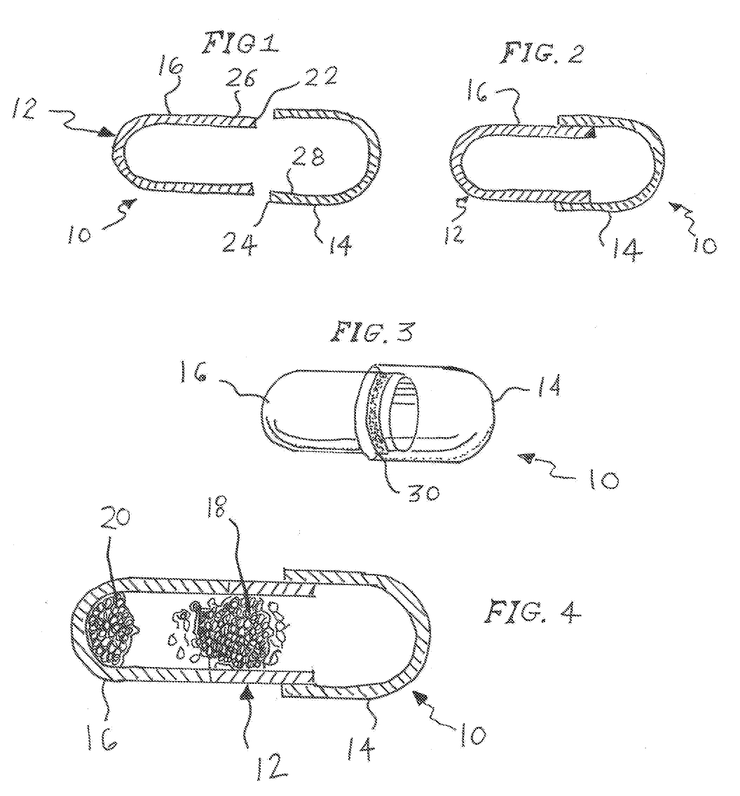

An exemplary embodiment of the capsule package of the present invention will now be described with reference to FIGS. 1-4 of the drawings.

As seen in FIG. 1, which is a longitudinal cross-sectional view of a capsule package of the invention in its open state, the capsule package is generally designated as the capsule package 10 and the capsule package 10 includes a wrap portion and a contents portions. The wrap portion of the capsule package 10, designated as the wrap portion 12, is formed in whole or in part of a material at least partially soluble in water. The wrap portion 12 as seen in FIG. 1 has an overfit section 14 and an underfit section 16. The overfit section 14 and the underfit section 16 are contoured to be secured to one another. In an manner described in more detail below, to encapsulate the contents portion of the capsule package 10 and this disposition of the wrap portion 12 is shown in FIG. 2, which is a longitudinal cross-sectional view of the capsule package 10 in its closed state. The contents portion of the capsule package 10 is inserted into the wrap portion 12 when the overfit section 14 and the underfit section 16 of the map portion 12 are not secured to one—i.e., when the capsule package 10 is in its open state as seen in FIG. 1. As seen in FIG. 4, which is a longitudinal cross-sectional view of the capsule package 10 in its closed state as shown in FIG. 2 and showing the content portion of the capsule package, the contents portion is formed of soap nuts 18 and a complement material 20.

The overfit section 14 and the underfit section 16 of the wrap portion 12 are configured to be welded together and, in connection with optimizing this welding attachment, the underfit section 16 of the wrap portion 12 includes an open end 22 that is compatibly configured with respect to an open end 24 of the overfit section 14 of the wrap portion 12 so that the open end 22 of the underfit section 16 will pass into the open end 24 of the overfit section 14 with the smallest gap that can be practically achieved to allow easy assembly. An annular raised rib 26 extends circumferentially around the exterior surface of the underfit section 16 and is compatibly configured with respect to an annular groove 28 extending circumferentially around the interior surface of the overfit section 14 to be received in this annular groove 28, whereupon a uniform repeatable fitting together of the overfit section 14 and the underfit section 16 of the wrap portion 12 is ensured.

When the overfit section 14 and the underfit section 16 of the wrap portion 12 are secured to one another (as shown in FIG. 2) the entire periphery of the open end 24 of the underfit section 14 is overlapped by the periphery of the open end 26 of the overfit section 14 and the capsule package 10 is ready for welding. The welding equipment (not shown), which can, for example, be welding equipment operable to perform laser welding such as, for example, infrared welding, forms a weld line 30 between the overfit section 14 and the underfit section 16, as seen in FIG. 3, which is a perspective view of the closed capsule package shown in FIG. 1 and showing one portion of the capsule package in a transparent see-through view.

At least one of the overfit section and the underfit section 16 of the wrap portion 12 is formed of a water soluble or water dispersible material or the overfit section 14 and the underfit section 16 are sufficiently water soluble or water dispersible so as to leave at least one aperture in the wall of the capsule package 10 when the capsule package is placed in contact with an aqueous environment. For example, at least one of the overfit section 14 and the underfit section 16 of the wrap portion 12 can be formed of pullulan, which is a vegetable-derived, water soluble polysaccharide produced via a fermentation process.

The soap nuts 18 can be obtained via any suitable agricultural production process including the harvesting of soap nuts from a soap nut tree, which is a large tree that grows in clusters and is known by the botanical name Sapindus trifolatus. To dispose the soap nuts 18 in a powdery form, any suitable powder production technique can be used including, for example, a particle size reduction technique wherein soap nuts are size reduced to produce a batch of relatively larger and relatively smaller particles. The smaller particles are separated from the remainder of the particles by screening. Thereafter the smaller particles, of a predetermined maximum size, are ground separately from the larger particles in a subsequent grinding step. The larger particles are replaced in the first grinding step. This process is repeated in a series of steps to produce a fine powder. Alternatively, the initial size reduction of a soap nut can be accomplished with the use of a mortar and pestle. A series of sieves, each having a predetermined screen size (i.e., the size of the openings in the screen of the sieve), can be used to separate the particles.

In some instances, it may be desirable that the wrap portion 12 of the capsule package 10 dissolves or otherwise exposes the soap nuts 18 to the aqueous media as rapidly as possible. In this connection, the complement material 20 can be specifically configured to ensure this rapid exposure. Thus, the complement material 20 may comprise solid acidic substances with carboxylic or sulphonic acid groups or salts thereof, cinnamic acid, tartaric acid, mandelic acid, fumaric acid, maleic acid, malic acid, pamoic acid, citric acid and naphthalene disulphonic acid, as free acids or as their alkali or alkaline-earth metal salts, with tartaric acid, citric acid, and cinnamic acid in the form of acids or their alkali metal salts. In one variations, the complement material is citric acid. The soap nuts 18 and the complement material 20 may be pre-mixed before being disposed in the wrap portion 12 or alternatively, the soap nuts 18 and the complement material 20 may each be separately added into the wrap portion 12, as is shown in FIG. 4, and remain as discrete compositions until the capsule package 10 is shaken or otherwise agitated.

The capsule package 10 may contain any cleaning agent or composition which is intended to be released when the container is placed in an aqueous environment. In this connection, the capsule package 10 may, for example, contain a fabric care, surface once or dishwashing composition. A fabric care composition is any composition which is used in the field of fabric care, such as in a fabric washing, fabric treating or dyeing process. A surface care composition is any composition which is used in the field of surface care such as, for example, to clear, treat or polish a surface. Suitable surfaces are, for example, household surfaces such as worktops, as well as surfaces of sanitary ware, such as sinks, basins and lavatories. A dishwashing composition is any composition which is used in the field of dishwashing, such as a dishwashing, water-softening or rinse aid composition.

The capsule package 10 may also be a component of a ready inventory kit whereby the kit also includes a storage covering that covers the capsule package. The storage covering may be used for storage and transport purposes such that when the capsule package 10 is to be deployed, a user dispose both the storage covering and the capsule package 10 in the water solution without the need to remove the capsule package 10 from the storage covering. In this regard, the storage covering may be formed of a a water soluble film forming polymeric material. As used herein, the term “water soluble film forming polymeric material” includes materials that are water dissolvable, materials that are water dispersible, and materials that are both water dissolvable and water dispersible. Suitable water soluble film forming polymeric materials include, for example, polyvinyl pyrrolidone-based polymers, polyethylene glycol, xantham gum, guar gum, polyquaternium polymers, pullulan, hydroxypropylmethyl cellulose, hydroxyethyl cellulose, hydroxypropyl cellulose gelatin, carboxymethyl cellulose, polyvinyl alcohol, sodium alginate, tragacanth gum, acacia gum, arabic gum, polyacrylic acid, methylmethacrylate copolymer, carboxyinvyl polymer, amylase, starches, modified starches, natural starches, aluminum starch octenyl succinate, hydroxy propyl starch phosphates, high amylase starch, hydroxypropylated high amylose starch, dextrin, pectin, chitan, chitosan, levan, elsinan, collagen, zein, glutan, soy protein isolate, why protein isolate, casein, locust bean gum, karaya gum, carrageenan, gellan, agar, algin, furcellaran, polyhydroxy acid polymers, and mixtures thereof. Particularly suitable water soluble film forming polymeric materials include starches, modified starches, natural starches, aluminum starch octenyl succinate, and hydroxy propyl starch phosphates. In accordance with one exemplary embodiment, the covering 26 may be made of polyvinyl alcohol, which is a water soluble synthetic polymer. Polyvinyl alcohol has excellent film forming, emulsifying, and adhesive properties. This material may be resistant to oil, grease and solvent, and may be odorless and nontoxic. Polyvinyl alcohol may have high oxygen and aroma barrier properties, but these properties may be dependent upon humidity. An increase in the water absorbed by the material may cause the tensile strength of the material to be reduced, but may increase elongation and tear strength. Polyvinyl alcohol may be fully degradable and may be a quick dissolver.

Polyvinyl alcohol used as the storage covering may have a density from 1.19-1.31 g/cm², a boiling point of 228 degrees Celsius, and a melting point of 230 degrees Celsius. Polyvinyl alcohol may be known as, or certain types of polyvinyl alcohol may be, PVOH, Poly(Ethenol), Ethenol, homopolymer, PVA, Polyviol, Vinol, Alvyl, Alkotex, Covol, Gelvatol, Lemol, Mowiol. The covering 26 may be made of a material that includes ingredients such as polyvinyl alcohol. For example, the covering 26 may be a polyvinyl nitrate or a polyvinyl acetal that include polyvinyl alcohol as a raw material. The polyvinyl alcohol may be arranged so that it is a water-soluble film. In accordance with other exemplary embodiments, the storage covering may be other types of vinyl polymers.

The storage covering may be a single rectangular sheet that is folded over itself to form folded edges and several units of the capsule package 10 may be covered by the folded over rectangular sheet. Additionally, suitable perforation lines or less than full depth score lines can be provided on the storage covering to facilitate the selection and separation of a suitable number of units of the capsule packages 10 for a given deployment scenario. Although described as being rectangular in shape, the storage covering can be variously shaped in other exemplary embodiments. Elementarily, it will be appreciated by those in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A package comprising:
a wrap portion formed in whole or in part of a material at least partially soluble in water; and
a contents portion formed of soap nuts and a complement material.

2. The package of claim 1, wherein the wrap portion includes an exterior surface and an interior lining and the interior lining is more resistant to the penetration thereof by an aqueous media than the exterior surface.

3. The package of claim 1, wherein the soap nuts are in powdery form.

4. The package of claim 4, wherein the complement material is a material that enhances a soil loosening property of soap nuts.

5. The package of claim 4, wherein the complement material is configured to accelerate the rate of dissolution of the wrap portion when in contact with aqueous media.

6. The package of claim 5, wherein the complement material is citric acid.

7. A capsule package comprising:
a wall having at least two molded components, the at least two sections including at least one moldable material that is water soluble or water dispersible or wherein a substantial part of the surface of the at least two sections is water soluble or water dispersible so as to leave at least one aperture in the wall when the capsule package is placed in contact with an aqueous environment, the at least two sections forming a compartment that is accessible to the aqueous environment when the capsule package is exposed to the aqueous environment; and
a contents portion formed of soap nuts and a complement material.

8. The capsule package according to claim 7 wherein the molded sections are wholly water soluble or water dispersible.

9. The capsule package according to claim 7 wherein the at least one material is soluble in an aqueous environment no greater than two hundred and ten degrees Fahrenheit.

10. The capsule package according to claim 7 wherein the at least one material is soluble in an aqueous environment no greater than one hundred degrees Fahrenheit.

11. The capsule package according to claim 7 wherein the sections are welded to form a single indivisible unit.

12. The capsule package according to claim 11 wherein the welding is on a line around the capsule package and wherein the line is situated on a planar cross-section of the capsule package.

13. The capsule package according to claim 12 wherein the welding is effected by laser welding.
